(19) United States
(12) Patent Application Publication
(10) Pub. No.: US 2025/0190782 A1
(43) Pub. Date: Jun. 12, 2025

(54) METHOD AND SYSTEM FOR DATA GENERATION CONTROL VIA MARGIN RELAXED SCHRODINGER BRIDGES

(71) Applicant: JPMorgan Chase Bank, N.A., New York, NY (US)

(72) Inventors: Eleonora KREACIC, London (GB); Rongzhe WEI, Atlanta, GA (US); Mohsen GHASSEMI, Jersey City, NJ (US); Vamsi Krishna POTLURU, New York, NY (US); Tucker Richard BALCH, Suwanee, GA (US); Manuela VELOSO, New York, NY (US)

(73) Assignee: JPMorgan Chase Bank, N.A., New York, NY (US)

(21) Appl. No.: 18/533,875

(22) Filed: Dec. 8, 2023

(51) Int. Cl. G06N 3/08

(52) U.S. Cl. CPC G06N 3/08

(57) ABSTRACT

Systems and methods for generating synthetic datasets having distributions that are close to those used as training sets for a generative model and for which a predefined feature of the dataset is close to a predefined value are provided. The method includes: receiving a first dataset that includes original data; determining an expression of a Schrodinger Bridge problem that corresponds to the first dataset; modifying the expression by introducing a term that relates to a transformation function; optimizing the transformation function with respect to a predetermined feature of the first dataset; and using the optimized transformation function to generate a second dataset that includes synthetic data.

### BACKGROUND

### 1. Field of the Disclosure

This technology relates to methods and systems for generating synthetic datasets having distributions that are close to those used as training sets for a generative model and for which a predefined feature of the dataset is close to a predefined value.

### 2. Background Information

Consideration is given to datasets characterized by d features of either numerical or categorical nature. More precisely, feature space X is either R^{d}, i.e., numerical datasets; of the form Ω^{d}:=Ω₁× . . . ×Ω_{d} where each dimension i is characterized by a number of distinct categories i.e. Ωᵢ∈N, i.e., categorical datasets, or of the form R^{d1}×Ω₁× . . . ×2_{d2} where d1+d2=d for mixed numerical/categorical datasets.

Let f:X→S represent a data statistic where S denotes the domain of the statistics. For example, f can be a binary label obtained based on the value of a certain feature, such as, for example, one (1) if the value of income is above a certain threshold and zero (0) otherwise; 1 if the city is New York, 0 otherwise; or an average value over a number of numerical columns, such as, for example, an average income over 12 numerical columns with client's monthly income. In many practical settings, it is important to be able to generate synthetic samples so that the value of some summary statistics lives within some desired subset of the domain.

Accordingly, there is a need for a method for generating synthetic datasets having distributions that are close to those used as training sets for a generative model and for which a predefined feature of the dataset is close to a predefined value.

### SUMMARY

The present disclosure, through one or more of its various aspects, embodiments, and/or specific features or sub-components, provides, inter alia, various systems, servers, devices, methods, media, programs, and platforms for generating synthetic datasets having distributions that are close to those used as training sets for a generative model and for which a predefined feature of the dataset is close to a predefined value.

According to an aspect of the present disclosure, a method for generating a synthetic dataset is provided. The method is implemented by at least one processor. The method includes: receiving, by the at least one processor, a first dataset that includes original data; determining, by the at least one processor, an expression of a Schrodinger Bridge problem that corresponds to the first dataset; modifying, by the at least one processor, the expression by introducing a term that relates to a transformation function; optimizing, by the at least one processor, the transformation function with respect to a predetermined feature of the first dataset; and using, by the at least one processor, the optimized transformation function to generate a second dataset that includes synthetic data.

The first dataset may include one from among numerical data, categorical data, and a mixture of numerical data and categorical data.

The predetermined feature may relate to a statistical characteristic of the first dataset.

The optimizing may include minimizing a difference between the first dataset and the second dataset with respect to a Kullback-Leibler (KL) divergence.

The term that relates to the transformation function may be generated by applying the KL divergence to the predetermined feature of the first dataset.

The optimizing may include executing an iterative algorithm that includes a forward diffusion process and a backward generation process with respect to a predetermined starting point and a predetermined end point.

In a discrete time setting, the forward diffusion process may correspond to a predetermined set of Markov transition densities and the backward generation process may correspond to a predetermined stochastic differential equation.

The executing of the iterative algorithm may include repeating the executing of the iterative algorithm until a result of the executing of the iterative algorithm corresponds to an accuracy that is less than a predetermined stopping accuracy threshold value.

The method may further include: using a result of each execution of the iterative algorithm to train a predetermined neural network; and using the trained neural network to generate the second dataset.

According to another exemplary embodiment, a computing apparatus for generating a synthetic data set is provided. The computing apparatus includes a processor; a memory; and a communication interface coupled to each of the processor and the memory. The processor is configured to: receive, via the communication interface, a first dataset that includes original data; determine an expression of a Schrodinger Bridge problem that corresponds to the first dataset; modify the expression by introducing a term that relates to a transformation function; optimize the transformation function with respect to a predetermined feature of the first dataset; and use the optimized transformation function to generate a second dataset that includes synthetic data.

The first dataset may include one from among numerical data, categorical data, and a mixture of numerical data and categorical data.

The predetermined feature may relate to a statistical characteristic of the first dataset.

The processor may be further configured to perform the optimization by minimizing a difference between the first dataset and the second dataset with respect to a Kullback-Leibler (KL) divergence.

The term that relates to the transformation function may be generated by applying the KL divergence to the predetermined feature of the first dataset.

The processor may be further configured to perform the optimization by executing an iterative algorithm that includes a forward diffusion process and a backward generation process with respect to a predetermined starting point and a predetermined end point.

In a discrete time setting, the forward diffusion process may correspond to a predetermined set of Markov transition densities and the backward generation process may correspond to a predetermined stochastic differential equation.

The processor may be further configured to perform the execution of the iterative algorithm by repeating the execution of the iterative algorithm until a result of the execution of the iterative algorithm corresponds to an accuracy that is less than a predetermined stopping accuracy threshold value.

The processor may be further configured to: use a result of each execution of the iterative algorithm to train a predetermined neural network; and use the trained neural network to generate the second dataset.

According to yet another exemplary embodiment, a non-transitory computer readable storage medium storing instructions for generating a synthetic data set is provided. The storage medium includes executable code which, when executed by a processor, causes the processor to: receive a first dataset that includes original data; determine an expression of a Schrodinger Bridge problem that corresponds to the first dataset; modify the expression by introducing a term that relates to a transformation function; optimize the transformation function with respect to a predetermined feature of the first dataset; and use the optimized transformation function to generate a second dataset that includes synthetic data.

The first dataset may include one from among numerical data, categorical data, and a mixture of numerical data and categorical data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for generating synthetic datasets having distributions that are close to those used as training sets for a generative model and for which a predefined feature of the dataset is close to a predefined value.

FIG. 4 is a flowchart of an exemplary process for implementing a method for generating synthetic datasets having distributions that are close to those used as training sets for a generative model and for which a predefined feature of the dataset is close to a predefined value.

FIG. 5 is an illustration of an optimal transformation function that is used in an execution of a method for generating synthetic datasets having distributions that are close to those used as training sets for a generative model and for which a predefined feature of the dataset is close to a predefined value, according to an exemplary embodiment.

FIG. 6 is a sketch of an iterative algorithm to be used in an execution of a method for generating synthetic datasets having distributions that are close to those used as training sets for a generative model and for which a predefined feature of the dataset is close to a predefined value, according to an exemplary embodiment.

FIG. 7 is an algorithm to be used in an execution of a method for generating synthetic datasets having distributions that are close to those used as training sets for a generative model and for which a predefined feature of the dataset is close to a predefined value, according to an exemplary embodiment.

FIG. 8 is another algorithm to be used in an execution of a method for generating synthetic datasets having distributions that are close to those used as training sets for a generative model and for which a predefined feature of the dataset is close to a predefined value, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

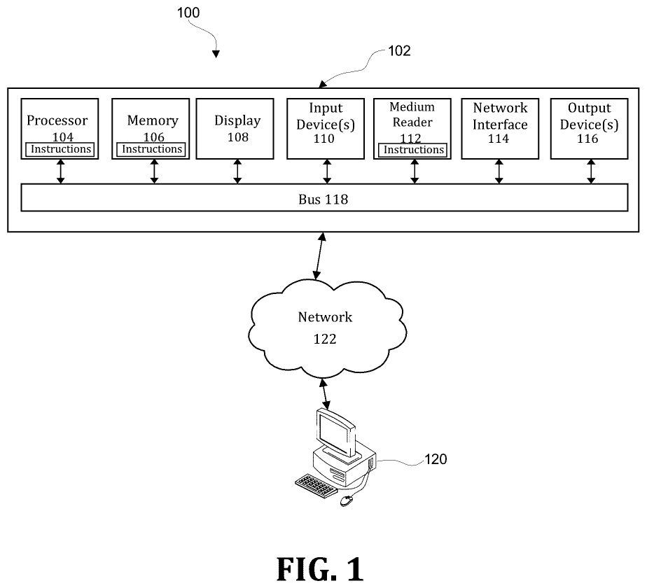

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for generating synthetic datasets having distributions that are close to those used as training sets for a generative model and for which a predefined feature of the dataset is close to a predefined value.

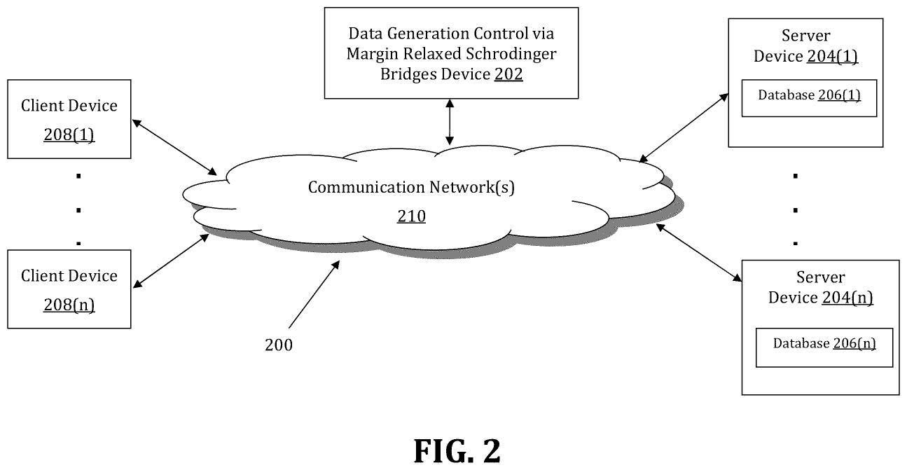

Referring to FIG. 2, a schematic of an exemplary network environment 200 for implementing a method for generating synthetic datasets having distributions that are close to those used as training sets for a generative model and for which a predefined feature of the dataset is close to a predefined value is illustrated. In an exemplary embodiment, the method is executable on any networked computer platform, such as, for example, a personal computer (PC).

The method for generating synthetic datasets having distributions that are close to those used as training sets for a generative model and for which a predefined feature of the dataset is close to a predefined value may be implemented by a Data Generation Control via Margin Relaxed Schrodinger Bridges (DGCMRSB) device 202. The DGCMRSB device 202 may be the same or similar to the computer system 102 as described with respect to FIG. 1. The DGCMRSB device 202 may store one or more applications that can include executable instructions that, when executed by the DGCMRSB device 202, cause the DGCMRSB device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DGCMRSB device 202 itself, may be located in virtual server(s) running in a cloud-based computing environment rather than being tied to one or more specific physical network computing devices. Also, the application(s) may be running in one or more virtual machines (VMs) executing on the DGCMRSB device 202. Additionally, in one or more embodiments of this technology, virtual machine(s) running on the DGCMRSB device 202 may be managed or supervised by a hypervisor.

In the network environment 200 of FIG. 2, the DGCMRSB device 202 is coupled to a plurality of server devices 204(1)-204(n) that hosts a plurality of databases 206(1)-206(n), and also to a plurality of client devices 208(1)-208(n) via communication network(s) 210. A communication interface of the DGCMRSB device 202, such as the network interface 114 of the computer system 102 of FIG. 1, operatively couples and communicates between the DGCMRSB device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DGCMRSB device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and DGCMRSB devices that efficiently implement a method for generating synthetic datasets having distributions that are close to those used as training sets for a generative model and for which a predefined feature of the dataset is close to a predefined value.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DGCMRSB device 202 may be a standalone device or integrated with one or more other devices or apparatuses, such as one or more of the server devices 204(1)-204(n), for example. In one particular example, the DGCMRSB device 202 may include or be hosted by one of the server devices 204(1)-204(n), and other arrangements are also possible. Moreover, one or more of the devices of the DGCMRSB device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DGCMRSB device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to content and statistics for original datasets and information that relates to utility metrics for synthetic dataset quality.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DGCMRSB device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the DGCMRSB device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the DGCMRSB device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DGCMRSB device 202, the server devices 204(1)-204(n), or the client devices 208(1)-208(n), for example, may be configured to operate as virtual instances on the same physical machine. In other words, one or more of the DGCMRSB device 202, the server devices 204(1)-204(n), or the client devices 208(1)-208(n) may operate on the same physical device rather than as separate devices communicating through communication network(s) 210. Additionally, there may be more or fewer DGCMRSB devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

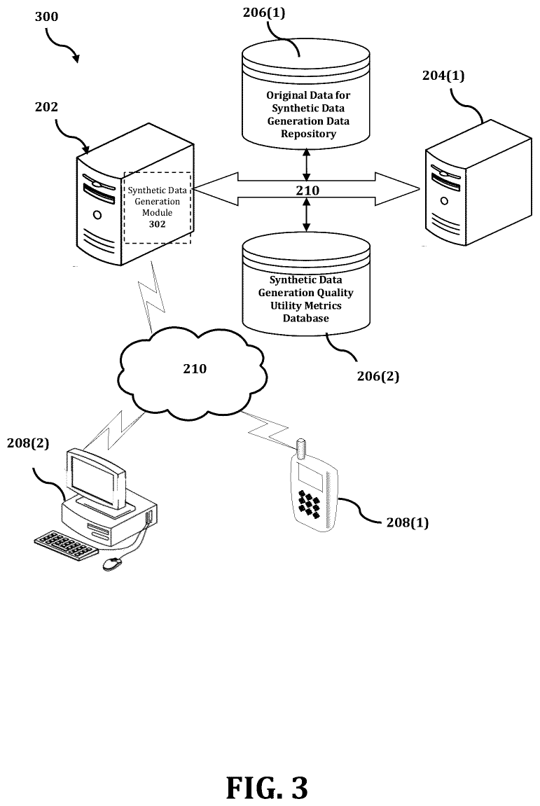

The DGCMRSB device 202 is described and illustrated in FIG. 3 as including a synthetic data generation module 302, although it may include other rules, policies, modules, databases, or applications, for example. As will be described below, the synthetic data generation module 302 is configured to implement a method for generating synthetic datasets having distributions that are close to those used as training sets for a generative model and for which a predefined feature of the dataset is close to a predefined value.

An exemplary process 300 for implementing a mechanism for generating synthetic datasets having distributions that are close to those used as training sets for a generative model and for which a predefined feature of the dataset is close to a predefined value by utilizing the network environment of FIG. 2 is illustrated as being executed in FIG. 3. Specifically, a first client device 208(1) and a second client device 208(2) are illustrated as being in communication with DGCMRSB device 202. In this regard, the first client device 208(1) and the second client device 208(2) may be “clients” of the DGCMRSB device 202 and are described herein as such. Nevertheless, it is to be known and understood that the first client device 208(1) and/or the second client device 208(2) need not necessarily be “clients” of the DGCMRSB device 202, or any entity described in association therewith herein. Any additional or alternative relationship may exist between either or both of the first client device 208(1) and the second client device 208(2) and the DGCMRSB device 202, or no relationship may exist.

Further, DGCMRSB device 202 is illustrated as being able to access an original data for synthetic data generation data repository 206(1) and a synthetic data generation quality utility metrics database 206(2). The synthetic data generation module 302 may be configured to access these databases for implementing a method for generating synthetic datasets having distributions that are close to those used as training sets for a generative model and for which a predefined feature of the dataset is close to a predefined value.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the DGCMRSB device 202 via broadband or cellular communication. Of course, these embodiments are merely exemplary and are not limiting or exhaustive.

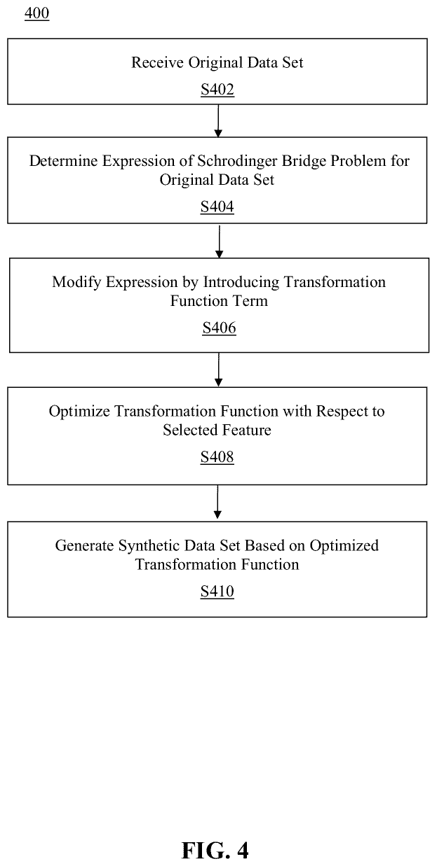

Upon being started, the synthetic data generation module 302 executes a process for generating synthetic datasets having distributions that are close to those used as training sets for a generative model and for which a predefined feature of the dataset is close to a predefined value. An exemplary process for generating synthetic datasets having distributions that are close to those used as training sets for a generative model and for which a predefined feature of the dataset is close to a predefined value is generally indicated at flowchart 400 in FIG. 4.

In process 400 of FIG. 4, at step S402, the synthetic data generation module 302 receives a set of original data that exists in a particular space or domain. In an exemplary embodiment, the original data set includes one from among numerical data, categorical data, and a mixture of numerical data and categorical data.

At step S404, the synthetic data generation module 302 determines an expression of the Schrodinger Bridge problem that corresponds to the original data set. Then, at step S406, the synthetic data generation module 30 modifies this expression by introducing a transformation function term.

At step S408, the synthetic data generation module 302 optimizes the transformation function with respect to a selected feature of the original data set. In an exemplary embodiment, the selected feature relates to a statistical characteristic of the original data set.

At step S410, the synthetic data generation module 302 uses the optimized transformation function to generate a synthetic data set that has a distribution that is close to the distribution of the original data set and for which the selected feature of the original data set is close to a predefined value.

In an exemplary embodiment, the optimization of the transformation function is performed in step S408 by minimizing a difference between the original data set and the synthetic data set with respect to a Kullback-Leibler (KL) divergence. In this aspect, the transformation function term used for modifying the Schrodinger Bridge problem expression in step S406 is generated by applying the KL divergence to the selected feature.

In an exemplary embodiment, the optimization may be performed by executing an iterative algorithm that includes a forward diffusion process and a backward generation process with respect to a predetermined starting point and a predetermined end point. In a discrete time setting, the forward diffusion process may correspond to a predetermined set of Markov transition densities and the backward generation process may correspond to a predetermined stochastic differential equation. These processes are described in further detail below.

In an exemplary embodiment, the execution of the iterative algorithm may be repeated until a result thereof corresponds to an accuracy that is within (i.e., less than) a predetermined stopping accuracy threshold value. In an exemplary embodiment, a result of each execution of the iterative algorithm may be used to train a predetermined neural network, and the trained neural network may be used to generate the synthetic data set in step S410.

In an exemplary embodiment, given a sample of data from a feature space X, an objective of the present inventive concept is to provide a method for data generation so that a probability measure of generated samples is close to a probability measure of the original data, and the value of a data statistic f takes on the generated sample is close to some predefined s∈S, where S is the domain of the data statistics. In this aspect, the present inventive concept provides a generative model that enables control of specified statistics of generated samples.

Formal Mathematical Setup-Notation: For a measurable feature space (X, G), let P(X) denote the space of probability measures on (X, G). In order to study time evolution of data under a Markov process, PT={P((Rd)t), t∈[0, T]} denotes a space of probability measures on paths in t∈[0, T] for the case of numerical data; analogously PT={P((Ωd)t), t∈[0, T]} for the discrete case, where Ωd:=Ω1× . . . ×Ωd and Ωi∈N. Given a distribution v0 over space X, let Pv0T={μ∈PT|μ0=v0} represent the probability measures over the space of paths that start at v0. Let Wp(·, ·) denote the Wasserstein p distance overP(X). We use DKL(·, ·) to denote KL-divergence.

Given a Borel function ƒ:X→Y, and a measure μ∈P(X), the following is a definition of the push forward operator f #:P(X)→P(Y):

$${f}_{\#} μ ( B ) := μ ( {f}^{- 1} ( B ) ) ∀ B ∈ \text{?} ( \text{?} )$$

$$\text{?} \text{indicates text missing or illegible when filed}$$

and f #μ is referred to as a push forward measure. In other words, f #u of any measurable set from Y is defined as the u measure of the set of elements from X that map to it.

Given a path π∈PT, let π_{t1, t2, . . . , tk} denote the marginalized measure over time (t1, t2, . . . , tk). Let π_{t+1|t(yti|ytj)} denote the transitional probability from yₜⱼ to yₜᵢ.

Diffusion Model: Consider a data distribution with positive density p_{data} and a predefined prior distribution pₚᵣᵢₒᵣ with respect to a Lebesgue measure with support R^{d}. In discrete time setting, the forward diffusion process can be described by Markov transition densities p_{k+|k}, k∈{0, 1, . . . , T1}. Consider the forward transition kernels of the following form:

$${p}_{k + 1 \vert k} = 𝒩 ( {x}_{k + 1} \text{?} {x}_{k} + {γ}_{k + 1} g ( {x}_{k} ) , {2}_{{γ}_{k + 1}} I ) .$$

$$\text{?} \text{indicates text missing or illegible when filed}$$

The backward generation process can be approximated as follows:

$$\text{?}$$

$$\text{?} \text{indicates text missing or illegible when filed}$$

Now, consideration is given to the continuous-time limit of the above procedure, and the above forward evolution can be described by the following stochastic differential equation (SDE):

$$\text{?}$$

$$\text{?} \text{indicates text missing or illegible when filed}$$

where Wt is the Wiener process. It is assumed that f satisfies some regular conditions. The reverse generation process ({Yₜ}_{t∈[0,T]}, Yₜ=X_{T-t}) can be described by the following SDE:

$$\text{?}$$

$$\text{?} \text{indicates text missing or illegible when filed}$$

The above SDE describes the evolution of diffusion and generation processes and the corresponding densities is fixed. Thus, the forward density p(x_{0:T}) and backward density q(y_{0:T}) are termed as reference densities.

Schrodinger Bridges. The Schrodinger Bridge problem is a classical problem in applied mathematics, stochastic control and probability. The formal dynamic form of the Schrodinger Bridge problem is given as follows: consider a reference density q∈PT, given observations qₚᵣᵢₒᵣ and q_{data}, the goal is to find π*∈PT such that

$$\text{?}$$

$$\text{?} \text{indicates text missing or illegible when filed}$$

After π* is available, in the generation process, one can sample data from qₚᵣᵢₒᵣ and generate data via path π*.

Methodology: Objective Function—Note that the reference densities can be viewed as paths in space PT. In the generation process, one intends to control the generation process with a specific statistic f(·):X→S in hope that the final destination measure for a sampling generated dataset is close to the original data measure but with statistics close to the desired value. Thus, given a specific distribution ρ* ∈P(S), consideration is given to the following marginal relaxed Schrodinger Bridge problem:

$$\text{?}$$

$$\text{?} \text{indicates text missing or illegible when filed}$$

The formulation provided above deviates from the conventional Schrodinger Bridge problem. While the original problem fixes two endpoint measures, in an exemplary embodiment, the approach introduces flexibility to the final destination using the KL divergence. However, given that ρ* and qT are distributions in distinct spaces, pinpointing optimal conditions for the functions becomes challenging. Therefore, the following modified version of the loss is proposed, where the distributions in the space of statistic are pulled back to the space of data:

$$\text{?}$$

$$\text{?} \text{indicates text missing or illegible when filed}$$

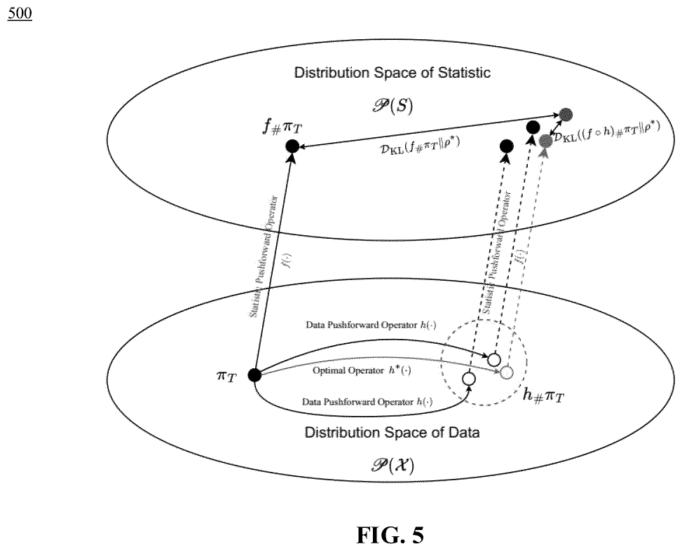

Illustration 500 of FIG. 5 describes the high level idea of this modification. Instead of directly optimizing D_{KL}(f #πT∥ρ*), consideration is given to a transformation h(·) in X such that h provides a new dataset based on the original dataset that follows πT. Thus, h induces a new measure h #πT in P(X). In the optimization problem, an optimal transformation h* is sought, such that f #(h* #πT) is the closest to ρ* in the sense of KL divergence. Note that h* might not be unique and the optimal transformation set depends on the statistic being considered.

Thus, in this case, the above objective function can be rewritten as

$$\text{?}$$

$$\text{?} \text{indicates text missing or illegible when filed}$$

In the following, consideration is given to a discrete time setting, noting that a continuous setting is similar with minor revisions. An intention is to reformulate the above rewritten form of the objective function such that it becomes easier to obtain the optimal conditions of two functions φ, \hat{ }φ to be relied on for constructing a Schodinger system.

Discrete Time Setting: For the reverse chain {q(yₜ₊₁|yₜ), t∈{0, 1, . . . , T−1}}, the following expression is true:

$$\text{?}$$

$$\text{?} \text{indicates text missing or illegible when filed}$$

where ∇ log qₜ(yₜ) can be learned via the score matching method.

The joint KL divergence is expended by using conditional KL divergence:

$$\text{?}$$

$$\text{?} \text{indicates text missing or illegible when filed}$$

In the next step, the intention is to relate the above conditional KL objective with two potential functions φ, \hat{ }φ in order to explicitly find out the optimal conditions of these two potential functions to be satisfied in order to construct the Schrodinger system.

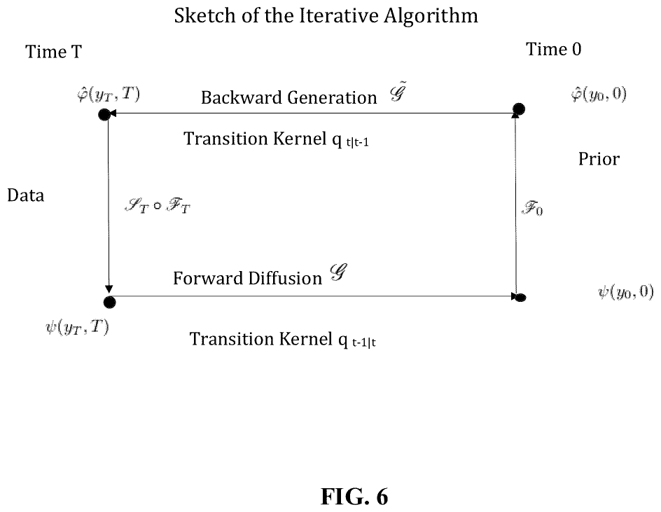

To find the optimal conditions of two functions φ, \hat{ }φ in order to minimize the above formula, a guess of the optimal form of π* is made as π*_{t+1|t} (yₜ₊₁|yₜ)=q_{t+1|t}(yₜ₊₁|yₜ)/φ(yₜ₊₁,t+1)/q(yₜ,t). Sketch 600 of FIG. 6 provides an illustration of this idea. To further test this guess, consideration is given to the following construction:

$$\text{?}$$

$$\text{?} \text{indicates text missing or illegible when filed}$$

Given that Σ_{y0} π₀(y₀) log [symbol] (y₀, 0)=Σ_{y0} q₀(y₀) log [symbol] (y₀,0) is independent from optimization variable π, and using the above equations, the original objective function [symbol] (π) is equivalent to minimizing the following:

$$\text{?}$$

$$\text{?} \text{indicates text missing or illegible when filed}$$

for all π∈ [symbol] .

Define ψ(yₜ,t)= [symbol] (yₜ,t)q(yₜ). Consideration is given to the following generalized Schrodinger system:

$$\text{?}$$

$$\text{?} \text{indicates text missing or illegible when filed}$$

and the optimal transition kernel is given by

$$\text{?}$$

$$\text{?} \text{indicates text missing or illegible when filed}$$

Then, the solution π* is unique and given by the following Markovian distribution:

$$\text{?}$$

$$\text{?} \text{indicates text missing or illegible when filed}$$

FIG. 6 is a sketch 600 of an iterative algorithm to be used in an execution of a method for generating synthetic datasets having distributions that are close to those used as training sets for a generative model and for which a predefined feature of the dataset is close to a predefined value, according to an exemplary embodiment.

In the generalized Schrodinger system, the first equation defines the forward diffusion process and the second equation represents the backward generation process. The third equation and the fourth equation are the hard constraints on the beginning and end point of the path. The constraint of the beginning point (i.e., the third equation) is the same with the traditional Schrodinger bridge problem, as the starting point is not relaxed, while the ending constraint is a bit different from the original Schrodinger Bridge problem, as the destination measure is relaxed.

The following maps are defined below to better describe the iterative algorithm:

$$\text{?}$$

$$\text{?} \text{indicates text missing or illegible when filed}$$

As shown in FIG. 6, G and G^{˜} denote the forward diffusion and backward diffusion respectively. F₀ is the normalization at time 0, while S_{T}·F_{T} denotes the normalization at time T. Thus, the whole iterative algorithm can be described as the following mapping composition: S_{T}·F_{T}·G^{˜}·F₀·G.

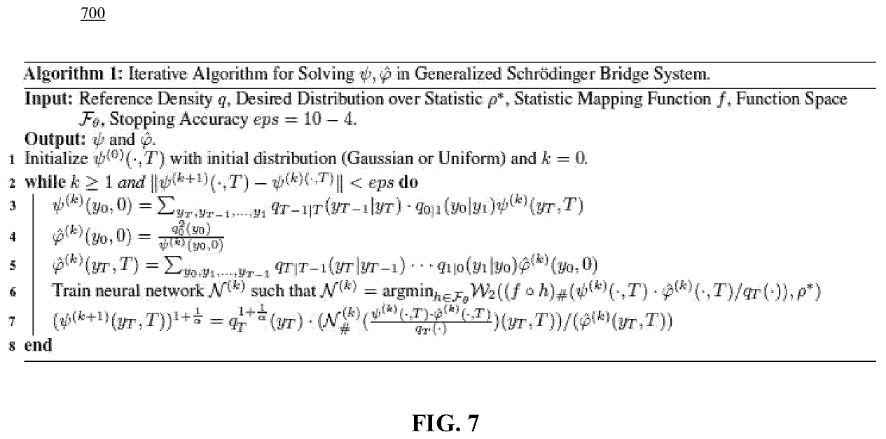

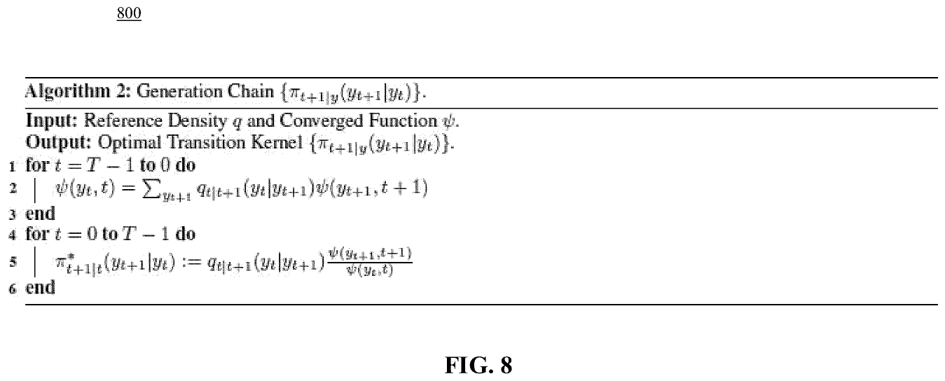

FIG. 7 is an algorithm 700 to be used in an execution of a method for generating synthetic datasets having distributions that are close to those used as training sets for a generative model and for which a predefined feature of the dataset is close to a predefined value, according to an exemplary embodiment. FIG. 8 is another algorithm 800 to be used in an execution of a method for generating synthetic datasets having distributions that are close to those used as training sets for a generative model and for which a predefined feature of the dataset is close to a predefined value, according to an exemplary embodiment.

Explanation: In algorithm 700, line 3 denotes the forward diffusion path, and line 4 describes the normalization at time 0. In line 5, the potential function goes through the backward generation process. For line 6, a neural network is trained in each round, noting that this kind of learning procedure in each round poses a challenge to prove the convergence, and the normalization is done at time T in line 7. In algorithm 800, the forward chain is taken as an input, and the converged helper function v is a result from algorithm 700. The desired generation kernel π is then recovered with the use of forward diffusion and backward generation maps, respectively, as illustrated in FIG. 6.

Accordingly, with this technology, an optimized process for generating synthetic datasets having distributions that are close to those used as training sets for a generative model and for which a predefined feature of the dataset is close to a predefined value is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a synthetic dataset, the method being implemented by at least one processor, the method comprising:
receiving, by the at least one processor, a first dataset that includes original data;
determining, by the at least one processor, an expression of a Schrodinger Bridge problem that corresponds to the first dataset;
modifying, by the at least one processor, the expression by introducing a term that relates to a transformation function;
optimizing, by the at least one processor, the transformation function with respect to a predetermined feature of the first dataset; and
using, by the at least one processor, the optimized transformation function to generate a second dataset that includes synthetic data.

2. The method of claim 1, wherein the first dataset comprises one from among numerical data, categorical data, and a mixture of numerical data and categorical data.

3. The method of claim 1, wherein the predetermined feature relates to a statistical characteristic of the first dataset.

4. The method of claim 1, wherein the optimizing comprises minimizing a difference between the first dataset and the second dataset with respect to a Kullback-Leibler (KL) divergence.

5. The method of claim 4, wherein the term that relates to the transformation function is generated by applying the KL divergence to the predetermined feature of the first dataset.

6. The method of claim 1, wherein the optimizing comprises executing an iterative algorithm that includes a forward diffusion process and a backward generation process with respect to a predetermined starting point and a predetermined end point.

7. The method of claim 6, wherein in a discrete time setting, the forward diffusion process corresponds to a predetermined set of Markov transition densities and the backward generation process corresponds to a predetermined stochastic differential equation.

8. The method of claim 6, wherein the executing of the iterative algorithm comprises repeating the executing of the iterative algorithm until a result of the executing of the iterative algorithm corresponds to an accuracy that is less than a predetermined stopping accuracy threshold value.

9. The method of claim 8, further comprising:
using a result of each execution of the iterative algorithm to train a predetermined neural network; and
using the trained neural network to generate the second dataset.

10. A computing apparatus for generating a synthetic dataset, the computing apparatus comprising:
a processor;
a memory; and
a communication interface coupled to each of the processor and the memory,
wherein the processor is configured to:
receive, via the communication interface, a first dataset that includes original data;
determine an expression of a Schrodinger Bridge problem that corresponds to the first dataset;
modify the expression by introducing a term that relates to a transformation function;
optimize the transformation function with respect to a predetermined feature of the first dataset; and
use the optimized transformation function to generate a second dataset that includes synthetic data.

11. The computing apparatus of claim 10, wherein the first dataset comprises one from among numerical data, categorical data, and a mixture of numerical data and categorical data.

12. The computing apparatus of claim 10, wherein the predetermined feature relates to a statistical characteristic of the first dataset.

13. The computing apparatus of claim 10, wherein the processor is further configured to perform the optimization by minimizing a difference between the first dataset and the second dataset with respect to a Kullback-Leibler (KL) divergence.

14. The computing apparatus of claim 13, wherein the term that relates to the transformation function is generated by applying the KL divergence to the predetermined feature of the first dataset.

15. The computing apparatus of claim 10, wherein the processor is further configured to perform the optimization by executing an iterative algorithm that includes a forward diffusion process and a backward generation process with respect to a predetermined starting point and a predetermined end point.

16. The computing apparatus of claim 15, wherein in a discrete time setting, the forward diffusion process corresponds to a predetermined set of Markov transition densities and the backward generation process corresponds to a predetermined stochastic differential equation.

17. The computing apparatus of claim 15, wherein the processor is further configured to perform the execution of the iterative algorithm by repeating the execution of the iterative algorithm until a result of the execution of the iterative algorithm corresponds to an accuracy that is less than a predetermined stopping accuracy threshold value.

18. The computing apparatus of claim 17, wherein the processor is further configured to:
use a result of each execution of the iterative algorithm to train a predetermined neural network; and
use the trained neural network to generate the second dataset.

19. A non-transitory computer readable storage medium storing instructions for generating a synthetic data set, the storage medium comprising executable code which, when executed by a processor, causes the processor to:
receive a first dataset that includes original data;
determine an expression of a Schrodinger Bridge problem that corresponds to the first dataset;
modify the expression by introducing a term that relates to a transformation function;
optimize the transformation function with respect to a predetermined feature of the first dataset; and
use the optimized transformation function to generate a second dataset that includes synthetic data.

20. The storage medium of claim 19, wherein the first dataset comprises one from among numerical data, categorical data, and a mixture of numerical data and categorical data.
